(19) United States
(12) Patent Application Publication
(10) Pub. No.: US 2015/0199861 A1
(43) Pub. Date: Jul. 16, 2015

(54) DOUBLE PROXIMITY-INTERROGATIVE SMART FOB SWITCHING OF ELECTRICAL DEVICE

(71) Applicant: Double Secured, Inc., Santa Fe Springs, CA (US)

(72) Inventors: Sukki HONG, Irvine, CA (US); Yong Moo Lee, Seoul (KR)

(73) Assignee: Double Secured, Inc., Santa Fe Springs, CA (US)

(21) Appl. No.: 14/155,763

(22) Filed: Jan. 15, 2014

(51) Int. Cl. G07C 9/00

(52) U.S. Cl. CPC G07C 9/00111

(57) ABSTRACT

A smart fob for interfacing with a smart module includes: a low frequency receiver for receiving a first password and a smart module ID number in a low frequency signal; a memory for storing a registration number with which the smart fob is registered to the smart module, a smart fob ID number for the smart fob and a stored smart module ID number; a processor for providing a second password derived from the first password and the registration number of the smart fob; a smart module ID detector connected to the low frequency receiver for waking-up the processor if the received smart module ID number in the low frequency signal matches the stored smart module ID number in the memory; and a high frequency transmitter for transmitting the second password in a high frequency signal.

### BACKGROUND OF THE INVENTION

1. Field Of The Invention

Embodiments of the invention relate to switching of an electrical device, and more particularly, to switching an electrical device in the proximity of a fob. Although the embodiments of the invention are suitable for a wide scope of applications, it is particularly suitable for activating an electric lock or for turning-on electrical power only when a specific fob is in proximity and de-activating the electric lock or turning-off electrical power when the specific fob is not in proximity.

2. Discussion Of The Related Art

In general, a proximity switching system has a receiving device and a fob that can transmit a wireless signal. A fob has to be sufficiently close to the receiving device such that a wireless signal transmitted from the fob can be received by the receiving device. The range within which the receiving device can receive wireless signals of the fob is the proximity. Accordingly, an increase in the signal strength of the fob or an increase in reception capability of the receiving device will increase the proximity. On the other hand, a decrease in the signal strength of the fob or a decrease in reception capability of the receiving device will decrease the proximity.

The two types of wireless fobs are an active fob and a reactive fob. An active fob transmits an activation code as result of a user pushing a button on the active fob. If the active fob is in proximity while the button is pushed, then the receiving device receives the activation code from the active fob and actuates and electrical device. A reactive fob transmits an activation code in response to a predetermined wireless wake-up ping from a receiving device. Typically, the reactive fob is inherently in proximity when receiving a wireless wake-up ping from a receiving device because the strength of the wireless wake-up is less than the signal transmission strength of the reactive fob. Upon receiving the wireless wake-up ping from the receiving device, the reactive fob transmits an activation code and then the receiving device receives the activation code from the reactive fob and actuates an electrical device.

In the cases of both the active fob and the reactive fob, the transmitted activation code is a set code transmitted from the fobs. The transmitted activation code can be captured or recorded during the wireless signal transmissions from the fobs. Thus, the transmitted activation code can be stolen and subsequently used inappropriately with the receiving device to actuate the electrical device.

Both the fob and the receiving device can be battery operated. Thus, power management is concern for both the fob and the receiving device. The receiving may also use power to activate a locking mechanism or an input pad that activates a locking mechanism. In general, the best power management is for a device not to be on when not needed or for parts of a device to not be on when not needed. However, the times of need are not predictable and manual activation, such as pushing a button on the receiving device to initiate the receiving device into interfacing with the fob is not convenient.

### SUMMARY OF THE INVENTION

Accordingly, embodiments of the invention are directed to a double proximity-interrogative smart fob switching of an electrical device that substantially obviates one or more of the problems due to limitations and disadvantages of the related art.

An object of embodiments of the invention is to provide a proximity-interrogative smart fob that is reactive to a predetermined smart module.

Another object of embodiments of the invention is to provide a proximity-interrogative smart module that is reactive to a predetermined smart fob.

Another object of embodiments of the invention is to provide of a proximity-interrogative fob that provides an identification number to the smart module to wake-up the smart module.

Another object of embodiments of the invention is to provide of a proximity-interrogative smart module that ignores a high frequency signal from a smart fob that is not associated with the smart module without waking up the smart module.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a smart fob for interfacing with a smart module includes: a low frequency receiver for receiving a first password and a smart module ID number in a low frequency signal; a memory for storing a registration number with which the smart fob is registered to the smart module, a smart fob ID number for the smart fob and a stored smart module ID number; a processor for providing a second password derived from the first password and the registration number of the smart fob; a smart module ID detector connected to the low frequency receiver for waking-up the processor if the received smart module ID number in the low frequency signal matches the stored smart module ID number in the memory; and a high frequency transmitter for transmitting the second password in a high frequency signal.

In another aspect, a smart module for actuating an electrical device in response to a smart fob includes: a low frequency transmitter for transmitting a first password and a smart module ID number in a low frequency signal; a polling timer controlling a length of time between transmissions of the first password along with the smart module ID number; a high frequency receiver for receiving a high frequency signal including a second password; a memory for storing a registration number with which the smart fob is registered to the smart module and for storing the smart module ID number; a processor for decrypting the second password and determining if the second password is from the smart fob registered to the smart module; a reset timer for running a predetermined period when the processor determines a second password is from the smart fob registered to the smart module; and a directed actuator for electrical actuation of the electrical device while the reset timer runs.

In yet another aspect, a system for actuating an electrical device includes: a low frequency transmitter in the smart module for transmitting a first password and a smart module ID number in a low frequency signal; a low frequency receiver in a smart fob for receiving the first password and the smart module ID number in the low frequency signal; a first processor in the smart fob for providing a second password derived from the first password and a registration number with which the smart fob is registered to the smart module; a high frequency transmitter in the smart fob for transmitting a high frequency signal including the second password and a smart fob ID number; a high frequency receiver in the smart module for receiving the high frequency signal including the second password and the smart fob ID number; a second processor in the smart module for decrypting the second password and determining if the second password is from the smart fob registered to the smart module; a reset timer for running a predetermined period when the second processor determines the second password is from the smart fob registered to the smart module; and a directed actuator for electrical actuation of the electrical device while the reset timer runs.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an illustration of a door lock on a door and a fob according to an embodiment of the invention.

FIG. 2 is an illustration of a door lock on a door with a key pad and a fob according to an embodiment of the invention.

FIG. 3 is an illustration of a door lock on a door with a finger pad and a fob according to an embodiment of the invention.

FIG. 4 is a flow diagram of a smart module in a device interacting with a smart fob to activate a relay in a device according to an embodiment of the invention.

FIG. 5 is a block diagram of a smart module in a device that either enables an input pad or activates a relay according to an embodiment of the invention.

FIG. 6 is a block diagram of a smart fob according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

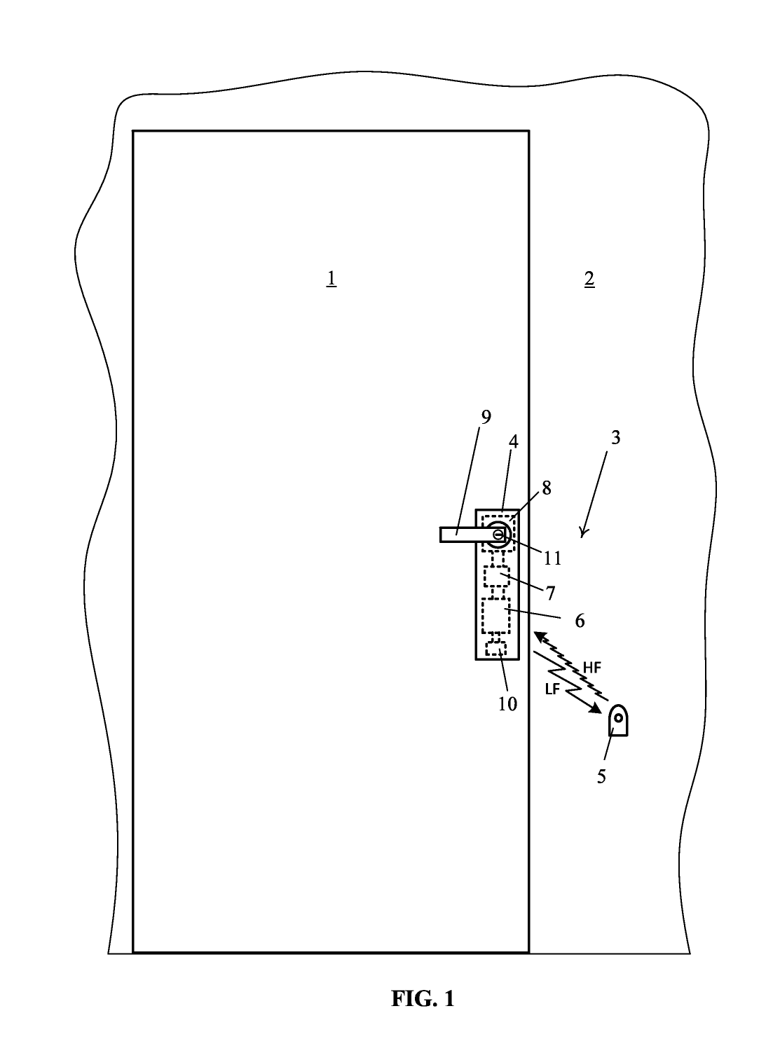

FIG. 1 is an illustration of a door lock on a door and a fob according to an embodiment of the invention. As shown in FIG. 1, a door 1 in wall 2 is secured by a locking system 3 having a locking device 4 and a smart fob 5. The locking device 4 includes a smart module 6 connected to a relay 7 that can enable an electro-mechanical latching mechanism 8 to engage with a door handle 9 such that turning of the door handle 9 will unlatch the door 1 for opening. The smart module 6 is also connected to a door sensor 10. When the smart fob 5 is in proximity to the smart module 6, the smart module 6 activates the relay 7 such that the door handle 9 can be used to unlatch the door 1. The door 1 can be opened while the relay 7 enables the electro-mechanical latching mechanism 8. When the smart fob 5 is no longer in proximity to the smart module 6 or the door sensor 10 senses the door 1 is open, the smart module 6 deactivates the relay 7 such that the electro-mechanical latching mechanism 8 is not enabled. A mechanical lock 11 turned with a key can be used to enable the door handle 9 to unlatch the door 1 to override the locking system 3 or for use in the event of a power failure in the locking device 4. Although a door lock on a door is shown in FIG. 1, the locking device 4 can also be used on a safe, drawer, gate or other closure mechanisms at which restricted access is desired.

Proximity for the smart fob 5 to the smart module 6 of the locking device 4 is dependent upon three aspects. First, the smart fob 5 must be able to receive a low frequency wireless signal containing a first password from the smart module 6. Second, the smart fob 5 must be registered to the smart module 6. Third, the smart module must be able to receive a high frequency wireless signal containing a second password from the smart fob 5. Thus, proximity for the smart fob 5 to the smart module 6 is controlled by how far the smart module 6 can transmit a low frequency wireless signal containing the first password, whether the smart fob 5 is registered to the smart module 6, and how far the smart fob 5 can transmit a high frequency wireless signal containing the second password. The smart module 6 should transmit a low frequency wireless signal containing the first password at a power level such that a distance within which the smart fob 5 receives the low frequency wireless signal containing is within the range of the smart fob 5 to transmit the high frequency wireless signal containing the second password to the smart module 6.

If the smart fob 5 receives the low frequency wireless signal containing the first password out of the range of the smart fob 5 to transmit the transmit the high frequency wireless signal containing the second password, then the smart fobs will waste power transmitting an unreceivable high frequency wireless signal. Embodiments of the invention include a smart fob that is battery powered and a smart fob that is powered by an external power source. In the case of a battery powered smart fob, the distance of proximity should be within the transmission range of the smart fob 5 to the smart module 6 for efficient battery usage.

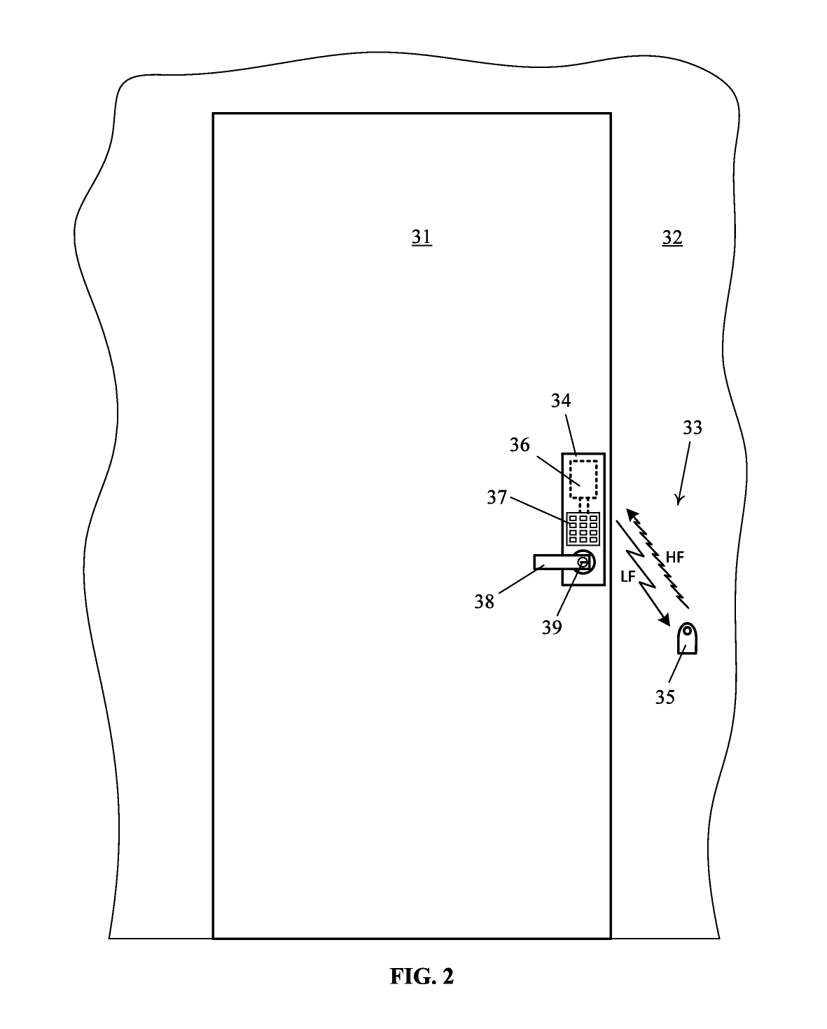

FIG. 2 is an illustration of a door lock on a door with a key pad and a fob according to an embodiment of the invention. The locking system 33 of FIG. 2 also includes that an additional security feature of a key pad 37 that requires the entry of an appropriated key code. This additional security feature prevents a stolen smart fob enabling entry.

As shown in FIG. 2, a door 31 in wall 32 is secured by a locking system 33 having a locking device 34 and a smart fob 35. The locking device 34 includes a smart module 36 connected to the key pad 37 that can enable a door handle 38 to open the door 31 when an appropriate key code is punched into the keypad 37. When the smart fob 35 is in proximity to the smart module 36, the smart module 36 activates the key pad 37 such that the key code can be entered and then the door handle 38 can be turned to open the door 31. When the smart fob 35 is no longer in proximity to the smart module 36, the smart module 36 deactivates the keypad 37 such that the door handle 38 will not open the door 31. A mechanical lock 39 turned with a key can be used to open the door 31 with the handle 38 to override the locking system 33 or for use in the event of a battery failure in the smart module 34. Although a door lock on a door is shown in FIG. 2, the locking device 34 can also be used on a safe, drawer, gate or other closure mechanisms at which restricted access is desired.

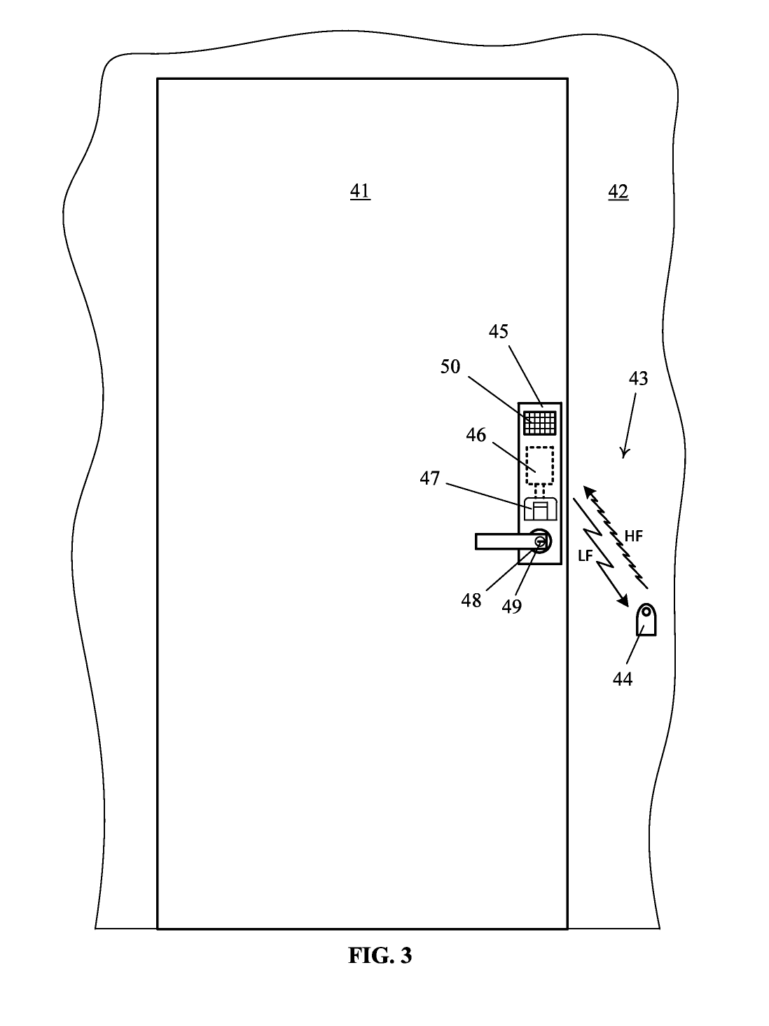

FIG. 3 is an illustration of a door lock on a door with a finger pad and a fob according to an embodiment of the invention. The locking system 43 of FIG. 3 also includes an additional security feature of a finger print pad 47 that requires the entry of an appropriated finger print. This additional security feature prevents a stolen smart fob enabling entry.

As shown in FIG. 3, a door 41 in wall 42 is secured by a locking system 43 having a locking device 44 and a smart fob 45. The locking device 44 includes a smart module 46 connected to a finger print pad 47 that can enable a door handle 48 to open the door 41 when an appropriate finger print is placed onto the finger print pad 47. When the smart fob 45 is in proximity to the smart module 46, the smart module 46 activates the finger print pad 47 such that a finger can be placed on the finger print pad 47 and then the handle 48 can be turned to open the door 41. When the smart fob 45 is no longer in proximity to the smart module 46, the smart module 46 deactivates the finger print pad 47 such that the door handle 48 will not open the door 41. A mechanical lock 49 turned with a key can be used to open the door 41 with the handle 48 to override the locking system 43 or for use in the event of a battery failure in the smart module 46. A solar panel 50 can be used to charge a battery within the smart module 46. Although a door lock on a door is shown in FIG. 3, the locking device 44 can also be used on a safe, drawer, gate or other closure mechanisms at which restricted access is desired.

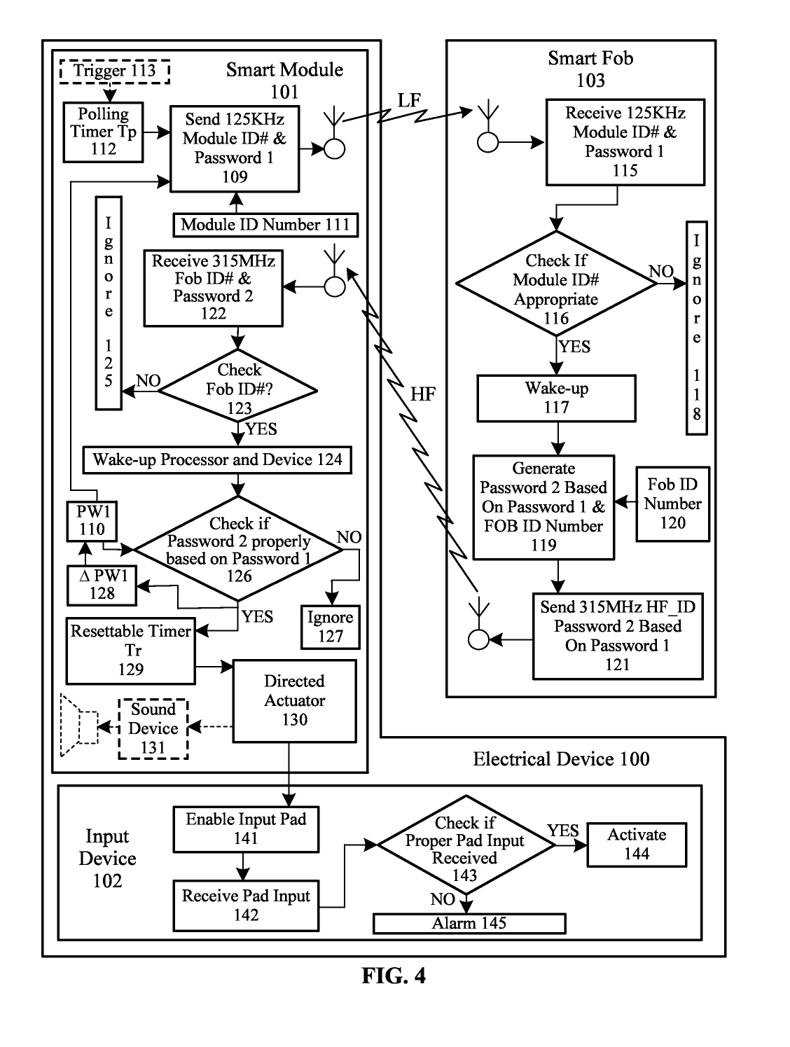

FIG. 4 is a flow diagram of a smart module in a device interacting with a smart fob to activate a relay in a device according to an embodiment of the invention. As shown in FIG. 4, a system for actuating an electrical device 100, including a smart module 101 and an input device 102, associated with a smart fob 103. The actuation process starts with the smart module 101 sending 109 a first password 110 and a module ID# 111 by a low frequency LF wireless transmission, such as 125 KHz, to the smart fob 103. The first password is randomly chosen and can be 16-bit, 24-bit or 32-bit. The module ID# 111 is a unique number for the smart module 101, like a serial number for that smart module 101. The module ID# 111 can be 16-bit, 24-bit or 32-bit.

The sending step 109 of the first password 110 and the module ID# 111 can be initiated by an auto-polling timer 112 that is constantly on or, in the alternative, a trigger 113 turns-on the auto-polling timer 112 for a period of time in response to an automatic triggering event, such as motion sensed by a motion sensor, or a manual triggering, such as a button being pressed. The period of time that the auto-polling timer 112 is triggered on can be the duration of the triggering event 113 or a set time period (i.e. a timed triggering) in response to a triggering event 113. The auto-polling timer 112 controls the length of time Tp between repeating transmissions of the low frequency LF wireless transmissions to put the smart-module. Triggering of the auto-polling timer 112 for sending 109 the first password 110 and the module ID# 111 saves power compared to the auto-polling timer 112 that is constantly on.

The smart fob 103 receives 115 the low frequency LF wireless transmission containing the first password 110 and the module ID#, as shown in FIG. 4. Then, the smart fob 103 checks 116 to see if the received module ID# is the module ID# 111 of the smart module 101 to which the smart fob 103 is registered. The smart fob 103 has a memory containing one or module ID#'s to which the smart fob 103 is registered. If the module ID# is to the smart module 101 to which the smart fob 103 is registered, then the smart fob 103 wakes-up 117. If the module ID# is to the smart module 101 to which the smart fob 103 does not recognize, then the smart fob 103 ignores 118 the low frequency LF wireless transmission containing a first password and a module ID#.

Prior to the smart fob wake-up 117, as shown in FIG. 4, the smart fob 103 is minimally powered such that only the receiving 115 and checking capability 116 of the smart fob 103 is powered up. Such a minimal power configuration conserves the battery of the smart fob 103 while maintaining the receiving 115 and checking capability 116. The smart fob 103 is only woke-up to be responsive to the smart module 101 to which the smart fob 103 is registered. The smart fob 103 ignores 118 a transmission from a smart module having a module ID# that is not in the memory of the smart fob 103.

After the smart fob 103 is woke-up 117, a second password is generated 119 based on the first password received and the fob registration number 120. In effect, a fob registration number 120 is like a private key used to encrypt the first password into a second password. In the smart module 101, the second password is decrypted using the first password to see if the registration number 120 results. Alternatively, private key like encryption methods can be used. For example, the second password is decrypted with the fob registration number, which is associated with a fob ID#, to see if the first password results.

As shown in FIG. 4, the second password and the fob ID# 121 are sent 121 to the smart module 101 by a high frequency HF wireless transmission, such as 315 MHz. The fob ID# 120 is a unique number for the smart fob 103, like a serial number for that smart fob 103. The fob ID# 120 can be 16-bit, 24-bit or 32-bit.

The sending 121 and generating 119 processes take the most power in the smart fob 103. By checking 116 to see if the module ID# 111 is for the smart module 101 to which the smart fob 103 is registered, battery power is conserved. The smart fob 103 can be awaken and send a second password upon receipt of the first transmission of first password or, alternatively, awaken on a first password transmission and then send a second password upon receipt of a second transmission of first password.

As shown in FIG. 4, the smart module 101 receives 122 the high frequency HF wireless transmission containing the second password and the fob ID#. The smart module 101 has a memory containing fob ID#'s registered to the smart module 101 as well as the fob registration numbers associated with the fob ID#'s. The smart module 101 checks 123 to see if the received fob ID# is the fob ID# 120 of the smart fob 103 registered to the smart module 101. If the fob ID# is registered to the smart module 101, then the processor of the smart module is woke-up 124. If the fob ID# is not registered to the smart module 101, then the smart module 101 ignores 125 the low frequency LF wireless transmission containing a second password and fob ID#.

Prior to the processor wake-up 124 in the smart module 101, as shown in FIG. 4, the smart module 101 is minimally powered such that only the sending 109, polling 112, triggering 113, receiving 122 and the fob ID# checking 123 capabilities of the smart module 101 are powered up. Such a minimal power configuration conserves the battery of the smart module 101 while maintaining the sending 109, polling 112, triggering 113, receiving 122 and the fob ID# checking 123 capabilities. The smart module 101 is only woke-up to be responsive to a smart fob 103 registered to the smart module 101. Thus, a transmission from the smart fob having a fob ID# that is not in the memory of the smart module 101 is ignored 125.

After the processor is woke-up 124, the second password is then checked 126 to see if the first password was properly encrypted based on the fob registration number of the smart fob having that particular fob ID#. If the second password is not properly encrypted based on the fob registration number for the fob ID#, then the smart module 101 ignores 127 the high frequency HF wireless transmission containing the second password and the fob ID# 120. If the second password is properly encrypted based on the fob registration number for a fob ID# of the smart fob 103 registered to the smart module 101, then the smart module 101 changes 128 the first password 110 for the next low frequency LF wireless transmission and pulses a resettable timer 129 to start the timer.

The resettable timer 129 runs for a period of time Tr upon receiving a pulse due to a check 126 of a second password being properly encrypted based on the fob registration number for the fob ID# 120 of the smart fob 103 registered to the smart module 101. The resettable timer 129 resets upon receipt each of subsequent pulse resulting from a check 126 that the first password was properly encrypted based on the fob registration number of the smart fob 103 registered to the smart module 101. To keep the resettable timer 126 continuously running by constantly restarting the resettable timer 129 while the smart fob 103 is in proximity to the smart module 101, the length of time Tp between the low frequency LF wireless transmissions controlled by the auto-polling timer 112 should be less than the period of time Tr for the resettable timer 129. For example, the length of time Tp for the auto-polling timer 112 is one second while the period of time Tr for the resettable timer 129 is three seconds.

As shown in FIG. 4, the resettable timer 129 enables a directed actuator 130 while the resettable timer 129 is running. The directed actuator 130 is an output buffer that provides an actuation signal with sufficient power to enable an external electrical device. For example, a relay of a device or an input pad 141 of the device 100, as shown in FIG. 4. In addition to relays and input pads, embodiments of the invention also include thyristors or any other type of electrical switching mechanisms to turn-on any type of electrical device.

The directed actuator 130 can turn-on a sound device 131, as shown in FIG. 4, to indicate that the directed actuator 130 has been enabled. Other types of indication devices, such as an LED can be additionally used. In the alternative, indication devices other than sound devices can be turned-on by the directed actuator 130.

When an input pad 141 of the input device 102 is powered by the directed actuator 130, the input pad can receive pad input 142, such as a finger print or keyed entry code. Then, there is a check if the proper pad input is received 143. If the pad input is proper, the unlocking mechanism 144 is activated such that the door can be opened. If the pad input is improper, an alarm 145 may occur.

When the resettable timer 129 enables the directed actuator 130, sensors 132 can also be turn-on to allow the resettable timer 129 to be reset until an event is sensed. When an event is sensed, the sensors 132 prevent the resettable timer 129 from resetting in response to a second password checked 126 as being from a registered smart fob in proximity. For example, the resettable timer 129 is no longer reset when a door is sensed by the sensors 132 to be open.

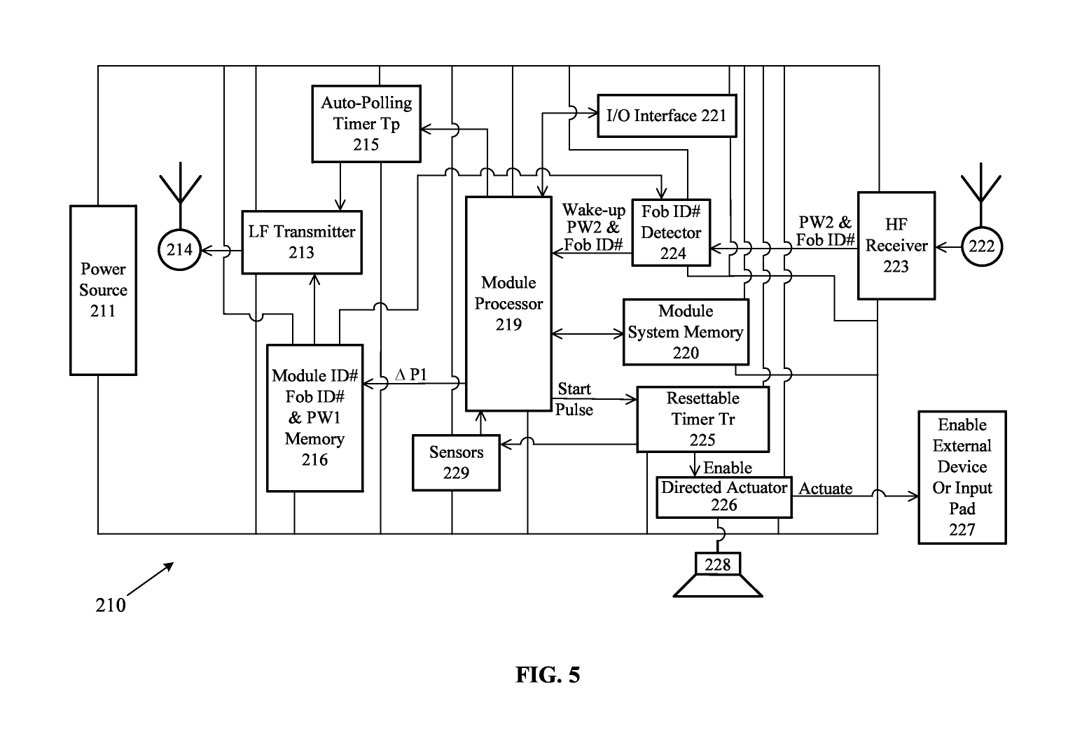

FIG. 5 is a block diagram of a smart module in a device that either enables an input pad or activates a relay according to an embodiment of the invention. As shown in FIG. 5, a smart module 210 includes a power source 211 that provides power to the components of the smart module 210. The power source 211 can be a battery, solar-assisted battery or external DC power supply.

Amongst other components in an electrical device for locking, the smart module 210 in FIG. 5 includes a low frequency transmitter 213 connected to a low frequency antenna 214. A module ID#, a fob ID# and a first password memory 216 provide the first password, the fob ID#, and the module ID# to the low frequency transmitter 213. An auto-polling timer 215 is connected to the low frequency transmitter 213 to control the length of time Tp between low frequency LF wireless transmissions, including a first password and a module ID#.

A module processor 219 is connected to the module ID#, the fob ID# and the first password memory 216, as shown in FIG. 5. The module processor 219 changes the first password in the module ID#, the fob ID# and the first password memory 216 after a use or attempted use of a previously transmitted first password. The module processor 219 randomly selects the next first password.

The module processor 219 in FIG. 5 is connected to the auto-polling timer 215. The module processor 219 can be used to set the length of time Tp between low frequency LF wireless transmissions, including a first password and a module ID#. For example, the length of time Tp for the auto-polling timer 215 can be long in a standby mode when a registered smart fob is not in proximity as opposed to an active mode when a registered smart fob is in proximity register.

As shown in FIG. 5, the module processor 219 is connected to a module system memory 220. The module processor 219 receives the decryption algorithms and other program for operation of the smart module 210 from the module system memory 220. The fob registration numbers of all registered smart fobs and the fob ID#'s respectively associated with the fob registration numbers are also stored in the module system memory 220.

An I/O interface 221 is connected to the module processor 219 in FIG. 5. The I/O interface 221 provides the capability to make changes to the smart module 210. Amongst other uses, the I/O interface 221 can be used to update the registry of fob registration numbers and fob ID#'s in the module ID#, the fob ID# and the first password memory 216. In another example, the I/O interface 221 can be used to set the length of time Tp for the auto-polling timer 215 to be longer so as to conserve power usage.

As shown in FIG. 5, a high frequency antenna 222 is connected to a high frequency receiver 223 for receiving a high frequency HF wireless transmission, including a second password and a fob ID#. The fob ID # detector 224 is connected to the high frequency receiver 223 and receives the second password and the fob ID# from the high frequency receiver 223. The fob ID # detector 224 is also connected to the module processor 219. If the fob ID# is from a smart fob registered to the smart module 210, the fob ID # detector 224 wakes-up the module processor 219. Then, the second password and the fob ID# are sent to the module processor 219. If the second password and the fob ID# are from a smart fob registered to the smart module 210, a start pulse is sent to the resettable timer 225, which is connected to the module processor 219.

The resettable timer 225, shown in FIG. 5, enables a directed actuator 226, which is connected to the resettable timer. The directed actuator 226 provides an actuation signal with sufficient power to enable an external electrical device or input pad 227. The directed actuator 226 can also turn-on the sound device 228. When the resettable timer 225 enables the directed actuator 226, sensors 229 can also be turn-on that turns-off the module processor 219 when a sensed event occurs.

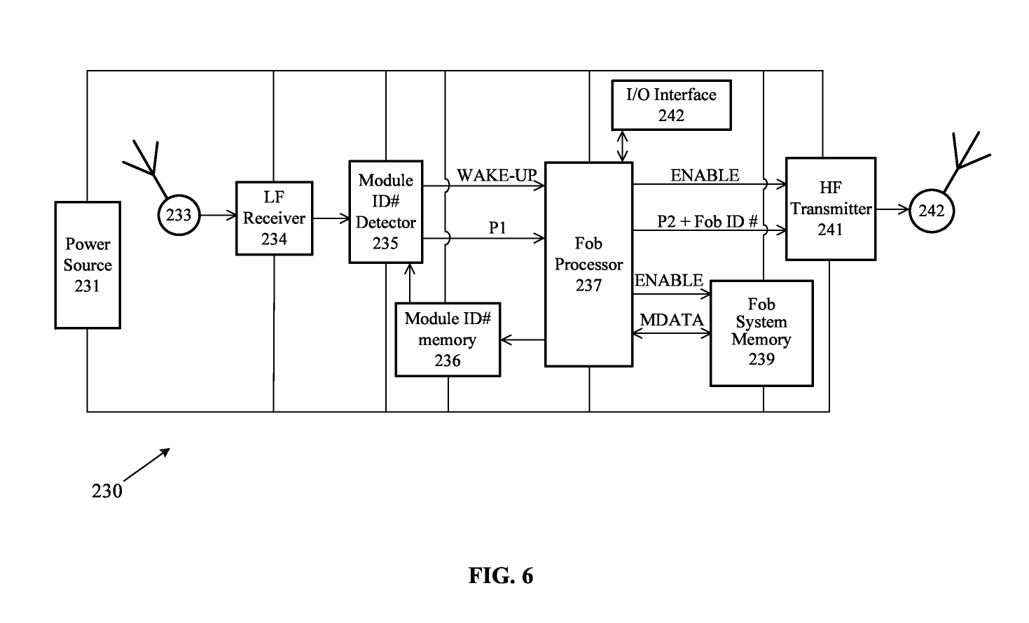

FIG. 6 is a block diagram of a smart fob according to an embodiment of the invention. As shown in FIG. 6, a smart module 230 includes a power source 231 that provides power to the components of the smart fob 230. The power source can be a battery or external DC power supply. In the case of an external DC power supply, a recharge circuit can be included that recharges the battery.

Amongst other components, the smart fob 230 in FIG. 6 includes a low frequency receiver 234 connected to a low frequency antenna 233 for receiving a module ID# and a first password. A module ID# detector 235 receives the module ID# and the first password from a low frequency receiver 234. A module ID# memory 236, which contains the module ID# of the smart module 230, is connected to the module ID# detector 235. The module ID# detector 235 determines if the module ID# is in the module ID# memory 236.

As shown in FIG. 6, the fob processor 237 is connected to the module ID# detector 235. The fob processor 237 is woke-up if the module ID# is from a smart module to which the smart fob 230 is registered. When the fob processor 237 is woke-up, the fob processor 237 enables a fob system memory 239 and a high frequency transmitter 241, which are connected to the fob processor 237. The fob processor 237 receives the encryption algorithms and other programs for operation of the smart fob 230 from the fob system memory 239. The fob registration number and the fob ID# for the smart fob 230 are also stored in the fob system memory 239.

Upon the wake-up, the first password is sent by the module ID# detector 235 to the fob processor 237 to generate a second password based on the first password received and a fob registration number stored in the fob system memory 239. Then, the fob processor 237 sends the second password and the fob ID# to the high frequency transmitter 241. A high frequency antenna 242 is connected to the high frequency transmitter 241 for transmitting a high frequency HF wireless transmission, including a second password and a fob ID#.

An I/O interface 240 is connected to the fob processor 237 in FIG. 6. The I/O interface 237 provides the capability to make changes to the smart fob 230. Amongst other uses, the I/O interface 242 can be used to update the fob registration number and the fob ID# in the fob system memory 239. In another example, the I/O interface 242 can be used to update the smart module ID# to which the smart fob 230 is registered in the module ID# memory 236.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. A smart fob for interfacing with a smart module, comprising:
a low frequency receiver for receiving a first password and a smart module ID number in a low frequency signal;
a memory for storing a registration number with which the smart fob is registered to the smart module, a smart fob ID number for the smart fob and a stored smart module ID number;
a processor for providing a second password derived from the first password and the registration number of the smart fob;
a smart module ID detector connected to the low frequency receiver for waking-up the processor if the received smart module ID number in the low frequency signal matches the stored smart module ID number in the memory; and
a high frequency transmitter for transmitting the second password in a high frequency signal.

2. The smart fob for interfacing with a smart module according to claim 1, wherein the processor is configured to receive the first password from the smart module ID detector after waking-up the processeor.

3. The smart fob for interfacing with a smart module according to claim 1, wherein the memory includes a first memory connected to the smart module detector and the processor for storing the smart module ID number and a second memory connected to the processor for storing the registration number.

4. The smart fob for interfacing with a smart module according to claim 3, wherein the processor is configured to enable the second memory.

5. The smart fob for interfacing with a smart module according to claim 3, wherein the processor is configured to enable the high frequency transmitter.

6. The smart fob for interfacing with a smart module according to claim 5, wherein the high frequency transmitter is configured to transmit the smart fob ID number and the second password.

7. A smart module for actuating an electrical device in response to a smart fob, comprising:
a low frequency transmitter for transmitting a first password and a smart module ID number in a low frequency signal;
a polling timer controlling a length of time between transmissions of the first password along with the smart module ID number;
a high frequency receiver for receiving a high frequency signal including a second password;
a memory for storing a registration number with which the smart fob is registered to the smart module and for storing the smart module ID number;
a processor for decrypting the second password and determining if the second password is from the smart fob registered to the smart module;
a reset timer for running a predetermined period when the processor determines a second password is from the smart fob registered to the smart module; and
a directed actuator for electrical actuation of the electrical device while the reset timer runs.

8. The smart module for actuating an electrical device in response to a smart fob according to claim 7, wherein the processor is configured to enable the low frequency transmitter to transmit the first password and the smart module ID number of the smart module.

9. The smart module for actuating an electrical device in response to a smart fob according to claim 6, wherein the memory includes a first memory connected to the low frequency transmitter and the processor for storing a smart module ID number and a second memory connected to the processor for storing the registration number.

10. The smart module for actuating an electrical device in response to a smart fob according to claim 7, wherein an indication device is connected to the directed actuator for indication while the directed actuator is actuated.

11. The smart module for actuating an electrical device in response to a smart fob according to claim 7, further comprising an I/O interface for enabling registration of a smart fob by inputting the registration number into the memory and connected to the processor.

12. The smart module for actuating an electrical device in response to a smart fob according to claim 7, wherein the length of time between transmissions controlled by the polling timer is set to be less than the predetermined period of the reset timer.

13. The smart module for actuating an electrical device in response to a smart fob according to claim 12, wherein the reset timer is configured to be restarted when the processor determines another second password is from the smart fob registered to the smart module.

14. The smart module for actuating an electrical device in response to a smart fob according to claim 13, wherein the memory stores a smart fob ID number of the smart fob registered to the smart module and the high frequency receiver receives the smart fob ID number with the second password.

15. The smart module for actuating an electrical device in response to a smart fob according to claim 13, further comprising a smart fob ID detector connected to the high frequency receiver for waking-up the smart module if a smart fob ID number in the high frequency signal matches the smart fob ID number in the memory.

16. A system for actuating an electrical device, comprising:
a low frequency transmitter in the smart module for transmitting a first password and a smart module ID number in a low frequency signal;
a low frequency receiver in a smart fob for receiving the first password and the smart module ID number in the low frequency signal;
a first processor in the smart fob for providing a second password derived from the first password and a registration number with which the smart fob is registered to the smart module;
a high frequency transmitter in the smart fob for transmitting a high frequency signal including the second password and a smart fob ID number;
a high frequency receiver in the smart module for receiving the high frequency signal including the second password and the smart fob ID number;
a second processor in the smart module for decrypting the second password and determining if the second password is from the smart fob registered to the smart module;
a reset timer for running a predetermined period when the second processor determines the second password is from the smart fob registered to the smart module; and
a directed actuator for electrical actuation of the electrical device while the reset timer runs.

17. A system for actuating an electrical device according to claim 16, further comprising;
a first memory in the smart fob for storing the smart module ID number of the smart module to which the smart fob is registered, the registration number with which the smart fob is registered to the smart module and the smart fob ID number.
an ID detector in the smart fob connected to the low frequency receiver for waking-up the smart fob if the smart module ID number in the low frequency signal matches the smart module ID number in the first memory.

18. A system for actuating an electrical device according to claim 17, wherein the second processor is configured to enable the high frequency transmitter to transmit the second password and the smart fob ID number of the smart fob.

19. A system for actuating an electrical device according to claim 18, further comprising;
a second memory in the smart module for storing the smart fob ID number of the smart fob registered to the smart module; and
a smart fob ID detector connected to the high frequency receiver for waking-up the smart module if the smart fob ID number in the high frequency signal matches the smart fob ID number in the second memory.

20. A system for actuating an electrical device according to claim 16, further comprising;
an auto-polling timer controlling a length of time between transmissions of the first password and the smart module ID number over a predetermined time frame,
wherein the length of time between transmissions the first password and the smart module ID number in the low frequency signal controlled by the auto-polling timer is set to be less than the predetermined period of the reset timer.
